(19) United States
(12) Patent Application Publication
(10) Pub. No.: US 2020/0061639 A1
(43) Pub. Date: Feb. 27, 2020

(54) SPRAY NOZZLE, COATING FORMING DEVICE, AND METHOD FOR FORMING COATING

(71) Applicant: TATSUTA ELECTRIC WIRE & CABLE CO., LTD., Higashiosaka-shi, Osaka (JP)

(72) Inventor: Masaki HIRANO, Kyoto (JP)

(73) Assignee: TATSUTA ELECTRIC WIRE & CABLE CO., LTD., Higashiosaka-shi, Osaka (JP)

(21) Appl. No.: 16/610,951

(22) PCT Filed: Feb. 22, 2018
(86) PCT No.: PCT/JP2018/006428

§ 371 Date: Nov. 5, 2019

(30) Foreign Application Priority Data
May 12, 2017 (JP) 2017-095729

(51) Int. Cl. B05B 1/12; B05D 1/02

(52) U.S. Cl. CPC B05B 1/12; B05B 7/1613; B05D 1/02

(57) ABSTRACT

A spray nozzle can control a film region easily. A spray nozzle of an embodiment includes, a nozzle main body, a nozzle tip section connected to a tip of the nozzle main body, and at least one path changing section which is provided in a passage of the carrier gas in the nozzle tip section and changes a path of the film material.

### TECHNICAL FIELD

The present invention relates to a spray nozzle, a film forming device, and a film forming method, each of which is for forming a film on a base material by spraying a film material, together with a carrier gas, onto the base material.

### BACKGROUND ART

In the field of electronics, electrical components and electrical circuits are becoming increasingly reduced in size and weight in recent years. Accordingly, there are increasing demands such as a demand for conducting a surface treatment (surface modification) of a micro-region and a demand for forming an electrode in a micro-region.

In order to meet such demands, great attention has been paid in recent years to a method for forming a film with use of a thermal spray method. For example, a cold spray method, which is a type of thermal spray method, is a method for (1) causing a carrier gas whose temperature is lower than a melting point or a softening temperature of a film material to flow at a high speed, (2) introducing the film material into the flow of the carrier gas and then increasing the speed of the carrier gas into which the film material has been introduced, and (3) forming a film by causing the film material to collide with, for example, a substrate at a high speed while the film material is in a solid phase.

Techniques of forming a film with use of the cold spray method are disclosed in Patent Literatures 1 and 2.

### CITATION LIST

### Patent Literature

[Patent Literature 1]

Japanese Patent Application Publication Tokukai No. 2011-240314 (Publication Date: Dec. 1, 2011)

[Patent Literature 2]

Japanese Patent Application Publication Tokukai No. 2009-120913 (Publication Date: Jun. 4, 2009)

### SUMMARY OF INVENTION

### Technical Problem

In the conventional cold spray method, masking is used in order to form a film in a desired region. Masking, however, decreases film formation efficiency in a case where an area unrelated to film formation exists.

Patent Literature 2 discloses a nozzle which, for improvement of film formation efficiency, has an opening at a tip section of the nozzle. However, even with use of the nozzle disclosed in Patent Literature 2, it is not easy to form a film in a desired region efficiently.

The present invention is accomplished in view of the aforementioned problem. An object of the present invention is to provide a spray nozzle, a film forming device, and a film forming method each of which can control a film region easily.

### Solution to Problem

In order to attain the object, a spray nozzle in accordance with the present invention is a spray nozzle to be applied to a film forming device which sprays a film material, together with a carrier gas, onto a base material so as to form a film on the base material, including: a nozzle main body; a nozzle tip section connected to a tip of the nozzle main body; and at least one path changing section which is provided in a passage of the carrier gas in the nozzle tip section and changes a path of the film material.

With the above arrangement, in a spray nozzle in accordance with an embodiment of the present invention, the at least one path changing section causes a change in a path of the film material. The change in the path of the film material causes a change in a film region on the base material. Thus, the spray nozzle in accordance with an embodiment of the present invention can control a film region on the base material with use of the at least one path changing section.

### Advantageous Effects of Invention

According to the present invention, the spray nozzle, the film forming device, and the film forming method of the present invention can each control a film region easily.

### BRIEF DESCRIPTION OF DRAWINGS

FIG. 1 is a cross-sectional view of a spray nozzle in accordance with an embodiment of the present invention.

FIG. 2 is a view schematically illustrating a cold spray device in accordance with an embodiment of the present invention.

FIG. 3 is a photograph illustrating a state in which a nozzle tip section is attached to a third body section.

FIG. 4 is a photograph illustrating a state in which the nozzle tip section has been removed from the third body section.

FIG. 5 is a perspective view of the nozzle tip section.

FIG. 6 is a view schematically illustrating a change in a path of a film material M, which change is caused by at least one path changing section.

FIG. 7 is a photograph of a surface of a base material on which a film of a film material has been formed without use of the at least one path changing section. (a) of FIG. 7 illustrates the nozzle tip section, and (b) of FIG. 7 is a photograph of the surface of the base material.

FIG. 8 is a photograph of a surface of a base material on which a film of a film material has been formed with use of one (1) path changing section. (a) of FIG. 8 illustrates the nozzle tip section, and (b) of FIG. 8 is a photograph of the surface of the base material.

FIG. 9 is a photograph of a surface of a base material on which a film of a film material has been formed with use of two path changing sections. (a) of FIG. 9 illustrates the nozzle tip section, and (b) of FIG. 9 is a photograph of the surface of the base material.

FIG. 10 is a cross-sectional view of a film region in a case where a film of the film material is formed on the base material without use of the at least one path changing section.

FIG. 11 is a cross-sectional view of a film region in a case where a film of the film material is formed on the base material with use of one (1) path changing section.

FIG. 12 is a cross-sectional view of a film region in a case where a film of the film material is formed on the base material with use of two path changing sections.

FIG. 13 is a view schematically illustrating a case in which a cross section of the at least one path changing section which cross section is taken along a direction in which a carrier gas flows is in a shape of a circle.

FIG. 14 is a view schematically illustrating a case in which a cross section of the at least one path changing section which cross section is taken along a direction in which a carrier gas flows is in a shape of a triangle.

FIG. 15 is a view schematically illustrating a case in which a cross section of the at least one path changing section which cross section is taken along a direction in which a carrier gas flows is in a shape of a rectangle.

### DESCRIPTION OF EMBODIMENTS

Embodiments are described below with reference to the drawings. In the following description, identical components and identical constituent elements are given respective identical reference signs. Such components and constituent elements are also identical in name and function. Thus, a specific description of those components and constituent elements is not repeated.

### Embodiment 1

Firstly, with reference to FIG. 2, the following description will discuss a cold spray device (film forming device) 100 in which a spray nozzle 10 in accordance with Embodiment 1 is used.

The following description will assume that the spray nozzle 10 is used in a cold spray method. However, the spray nozzle 10 is also applicable to other thermal spray methods (flame spraying, high velocity flame spraying, HVOF, FVAF, plasma spraying, or the like). Further, the cold spray method is roughly classified into high-pressure cold spraying and low-pressure cold spraying, depending on working gas pressures. The spray nozzle 10 in accordance with Embodiment 1 can be applied to both the high-pressure cold spraying and the low-pressure cold spraying.

Cold Spray

In recent years, a film forming method that is called a cold spray method has been used. The cold spray method is a method for causing a carrier gas whose temperature is lower than a melting point or a softening temperature of a film material to flow at a high speed, introducing the film material into the flow of the carrier gas and then increasing the speed of the carrier gas into which the film material has been introduced, and forming a film by causing the film material to collide with, for example, a base material at a high speed while the film material is in a solid phase.

A principle of film formation by the cold spray method is understood as below.

A collision speed of not less than a certain critical value is required for a film material to adhere to and accumulate on a base material so as to form a film. Such a collision speed is referred to as a critical speed. In a case where the film material collides with the base material at a speed that is less than the critical speed, the base material is worn, so that small crater-shaped cavities are merely formed in the substrate. The critical speed is changed by, for example, a material, a size, a shape, a temperature, and/or an oxygen content of the film material, or a material of the base material.

In a case where the film material collides with the base material at a speed that is not less than the critical speed, plastic deformation caused by a great shearing force occurs near an interface between the film material and the base material (or the film which has already been formed). The plastic deformation and generation of a great shock wave in a solid due to the collision cause an increase in temperature near the interface, and in this process, solid phase bonding occurs between the film material and the base material and between the film material and the film (or the film material which has already adhered to the base material).

Non-limiting examples of the film material can encompass the following materials.

### 1. Pure Metal

Copper (Cu), aluminum (Al), titanium (Ti), silver (Ag), nickel (Ni), zinc (Zn), tin (Sn), molybdenum (Mo), iron (Fe), tantalum (Ta), niobium (Nb), silicon (Si), or chromium (Cr)

### 2. Low-Alloy Steel

Ancorsteel 100

### 3. Nickel Chromium Alloy

50Ni-50Cr, 60Ni-40Cr, or 80Ni-20Cr

### 4. Nickel-Base Superalloy

Alloy625, Alloy718, Hastelloy C, or In738LC

5. Stainless steel

SUS304/304L, SUS316/316L, SUS420, or SUS440

6. Zinc alloy: Zn-20Al
7. Aluminum alloy: A1100 or A6061
8. Copper alloy: C95800 (Ni-AL Bronze) or 60Cu-40Zn

### 9. MCrAlY: NiCrAlY or CoNiCrAlY

10. Other: An amorphous (quasicrystalline) metal, a composite material, a cermet, or a ceramic

Cold Spray Device 100

FIG. 2 is a view schematically illustrating the cold spray device 100. As illustrated in FIG. 2, the cold spray device 100 includes a tank 110, a heater 120, a spray nozzle 10, a feeder 140, a base material holder 150, and a control device (not illustrated).

The tank 110 stores therein a carrier gas. The carrier gas is supplied from the tank 110 to the heater 120. Examples of the carrier gas include nitrogen, helium, air, or a mixed gas of nitrogen, helium, and air. A pressure of the carrier gas is adjusted so that the pressure is, for example, not less than 70 PSI and not more than 150 PSI (not less than approximately 0.48 Mpa and not more than approximately 1.03 Mpa) at an exit of the tank 110. Note, however, that the pressure of the carrier gas at the exit of the tank 110 does not necessarily need to fall within the above range, and is appropriately adjusted in accordance with, for example, material(s) and/or a size of a film material, or material(s) of a base material.

The heater 120 heats the carrier gas which has been supplied from the tank 110. More specifically, the carrier gas is heated to a temperature that is lower than a melting point of the film material which is supplied from the feeder 140 to the spray nozzle 10. For example, the carrier gas which is subjected to measurement at an exit of the heater 120 is heated to a temperature in a range of not less than 50° C. and not more than 500° C. Note, however, that a heating temperature of the carrier gas does not necessarily need to fall within the above range, and is appropriately adjusted in accordance with, for example, the material(s) and/or the size of the film material, or the material(s) of the base material.

The carrier gas is heated by the heater 120 and then is supplied to the spray nozzle 10.

The spray nozzle 10 (i) causes an increase in speed of the carrier gas which has been heated by the heater 120 to a speed in a range of not less than 300 m/s and not more than 1200 m/s and (ii) causes the carrier gas to be sprayed therethrough onto a base material 20. Note, however, that the speed of the carrier gas does not necessarily need to fall within the above range, and is appropriately adjusted in accordance with, for example, the material(s) and/or the size of the film material, or the material(s) of the base material.

The feeder 140 supplies the film material to the flow of the carrier gas whose speed is increased by the spray nozzle 10. The film material which is supplied from the feeder 140 has a particle size of, for example, not less than 1 μm and not more than 50 μm. Together with the carrier gas, the film material which has been supplied from the feeder 140 is sprayed through the spray nozzle 10 onto the base material 20.

The base material holder 150 fixes the base material 20. Onto the base material 20 which has been fixed by the base material holder 150, the carrier gas and the film material are sprayed through the spray nozzle 10. A distance between a surface of the base material 20 and a tip of the spray nozzle 10 is adjusted so that the distance falls within a range of, for example, not less than 1 mm and not more than 30 mm. In a case where the distance between the surface of the base material 20 and the tip of the spray nozzle 10 is less than 1 mm, a film formation speed is decreased. This is because the carrier gas sprayed from the spray nozzle 10 flows back into the spray nozzle 10. At this time, a pressure generated when the carrier gas flows back may cause a member (e.g., a hose) connected to the spray nozzle 10 to be detached. Meanwhile, in a case where the distance between the surface of the base material 20 and the tip of the spray nozzle 10 is more than 30 mm, efficiency in film formation is decreased. This is because it becomes more difficult for the carrier gas and the film material which have been sprayed from the spray nozzle 10 to reach the base material 20.

Note, however, that the distance between the surface of the base material 20 and the tip of the spray nozzle 10 does not necessarily need to fall within the above range, and is appropriately adjusted in accordance with, for example, the material(s) and/or the size of the film material, or the material(s) of the base material.

The control device controls the cold spray device 100 in accordance with information stored therein in advance and/or an input by an operator. Specifically, the control device controls, for example, (i) the pressure of the carrier gas which is supplied from the tank 110 to the heater 120, (ii) the temperature of the carrier gas which is heated by the heater 120, (iii) a kind and an amount of the film material which is supplied from the feeder 140, and (iv) the distance between the surface of the base material 20 and the spray nozzle 10.

Spray Nozzle 10

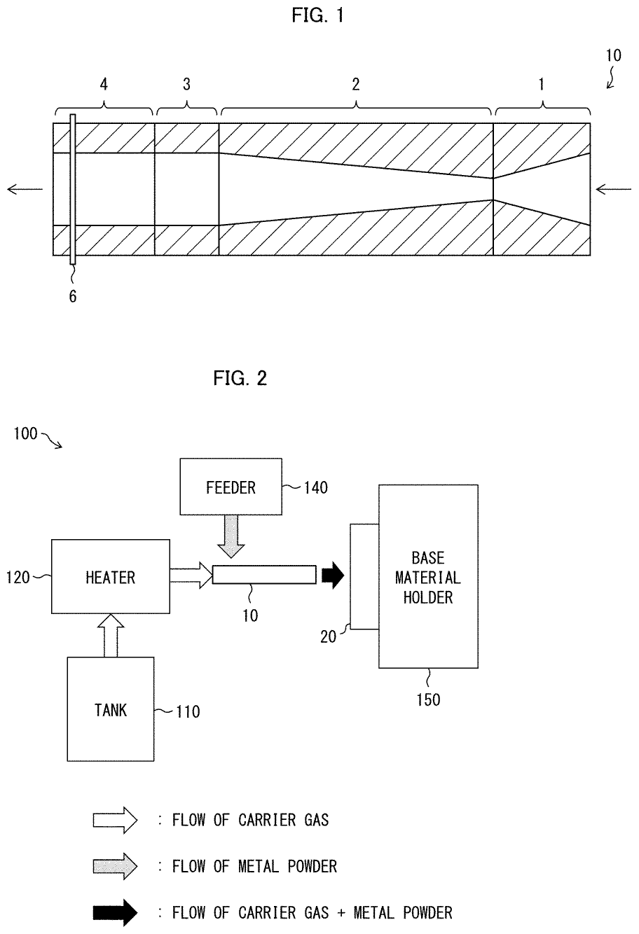

The following description will discuss the spray nozzle 10 with reference to FIG. 1 etc. FIG. 1 is a cross-sectional view of the spray nozzle 10.

The spray nozzle 10 is used for forming a film on the base material 20 by spraying the film material, together with the carrier gas, on the base material 20. The spray nozzle 10 includes a first body section 1, a second body section 2, a third body section 3, a nozzle tip section 4, and at least one path changing section 6.

Note that the first body section 1, the second body section 2, the third body section 3, and the nozzle tip section 4 may be formed integrally. Alternatively, the first body section 1, the second body section 2, the third body section 3, and the nozzle tip section 4 may be formed as separate members, and be screwed to or detachably connected to each other via a screw or the like.

The first body section 1, the second body section 2, and the third body section are collectively referred to as a nozzle main body. Note that the first body section 1 and the second body section 2 may be collectively referred to as a nozzle main body. In such a case, the third body section may be regarded as part of the nozzle tip section 4, and the third body section and the nozzle tip section 4 may be referred to as a nozzle tip section. A commercially available standard spray nozzle can be used, as it is, as the nozzle main body.

The spray nozzle 10 may have an arrangement such as a feed opening to which the film material is fed from the feeder 140, but details of such an arrangement are omitted in the drawings.

A direction in which the carrier gas flows in the spray nozzle 10 is indicated by arrows in FIG. 1 (a right-to-left direction of a drawing sheet of FIG. 1). The carrier gas is supplied to the first body section 1 of the spray nozzle 10 after being heated by the heater 120.

In the first body section 1, a passage of the carrier gas gradually becomes smaller along the flow of the carrier gas. This causes an increase in speed of the carrier gas in the first body section 1.

Subsequent to the first body section 1, the second body section 2 is provided. In the second body section 2, a passage of the carrier gas gradually becomes larger along a flow of the carrier gas. Accordingly, in the spray nozzle 10, the carrier gas is expanded in the second body section 2, and this expansion of the carrier gas causes the film material to accelerate.

Subsequent to the second body section 2, the third body section 3 is provided. In the third body section 3, a shape of a passage of the carrier gas is constant along a flow of the carrier gas. Note that in the third body section 3, the shape of the passage of the carrier gas may be constant, become larger, or become smaller, but preferably is constant or becomes larger.

Subsequent to the third body section 3, the nozzle tip section 4 is provided. In the nozzle tip section 4, a shape of a passage of the carrier gas is constant along a flow of the carrier gas. Note that in the third body section 3, the shape of the passage of the carrier gas may be constant, become larger, or become smaller, but preferably is constant or becomes larger.

In each of the first body section 1, the second body section 2, the third body section 3, and the nozzle tip section 4, a cross section of the passage of the carrier gas which cross section is taken along a direction perpendicular to a direction in which the carrier gas flows is in a shape of a circle. Note, however, that the cross section may be in other shapes.

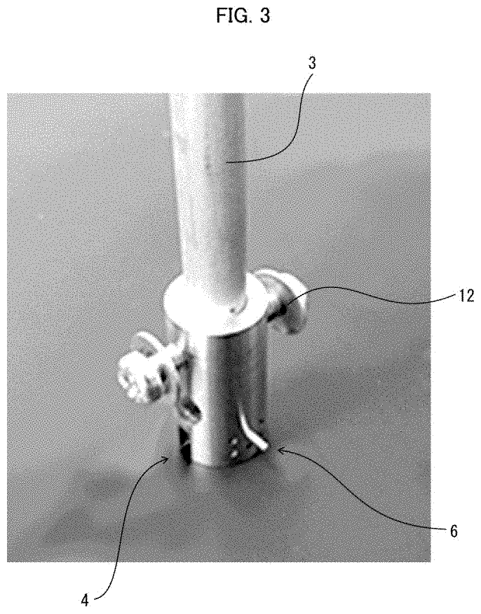

Into the nozzle tip section 4, the at least one path changing section 6 is inserted. The at least one path changing section 6 causes a change in a path of the film material passing through an inside of the nozzle tip section 4. The following description will discuss the nozzle tip section 4 and the at least one path changing section 6 in detail with reference to FIG. 3 etc.

Note that the following description deals with a case in which, in a direction perpendicular to the direction in which the carrier gas flows, the at least one path changing section 6 intersects the passage of the carrier gas in the nozzle tip section 4. Note that the at least one path changing section 6 may intersect the passage of the carrier gas in the nozzle tip section 4 so as to make an angle of more than 0° but less than 90° with respect to the direction in which the carrier gas flows. Alternatively, the at least one path changing section 6 does not necessarily need to intersect the passage of the carrier gas in the nozzle tip section 4 in the direction perpendicular to the direction in which the carrier gas flows.

The at least one path changing section 6 can thus be provided in various fashions with respect to the passage of the carrier gas inside the nozzle tip section 4, provided that the at least one path changing section 6 causes a change in the path of the film material passing through the inside of the nozzle tip section 4.

Nozzle Tip Section 4 and at Least One Path Changing Section 6

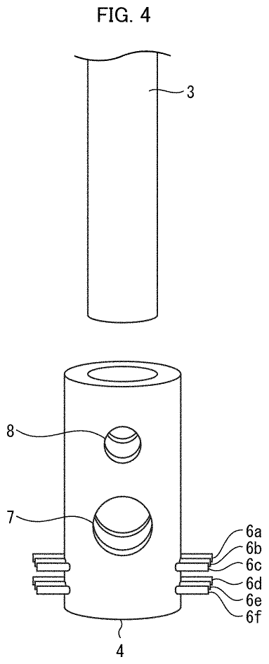

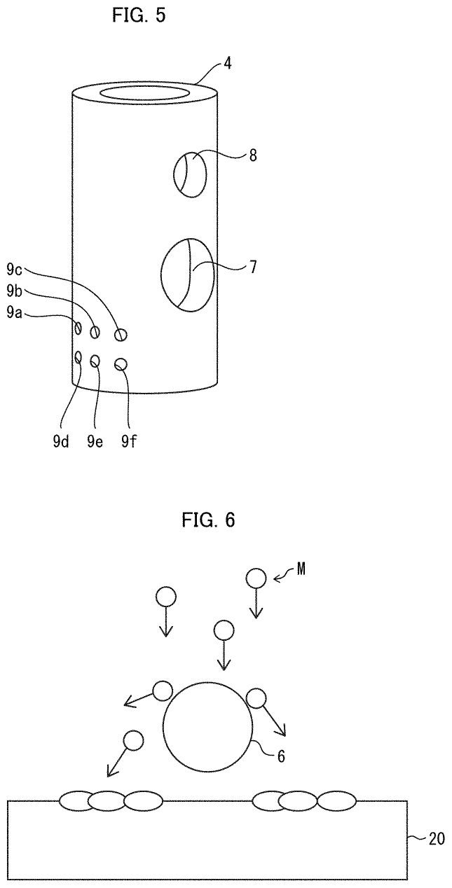

FIG. 3 is a photograph illustrating a state in which the nozzle tip section 4 is attached to the third body section 3. FIG. 4 is a view illustrating a state in which the nozzle tip section 4 has been removed from the third body section 3. FIG. 5 is a perspective view of the nozzle tip section 4.

As illustrated in FIGS. 3 and 4, the nozzle tip section 4 is attachable to and detachable from the third body section 3. The nozzle tip section 4 has an opening 7 and an opening 8. The nozzle tip section 4 and the third body section 3 are fixed to each other by a screw 12 inserted into the opening 8.

A portion of the carrier gas is released to an outside of the nozzle tip section 4 through the opening 7. This reduces a backward flow of the carrier gas inside the nozzle tip section 4, and accordingly allows the film material to be sprayed onto the base material 20 without interference of the acceleration of the film material.

As illustrated in FIGS. 3 and 4, the at least one path changing section 6 is inserted into the nozzle tip section 4. In FIG. 3, one (1) path changing section 6 is inserted into the nozzle tip section 4. In FIG. 4, six path changing sections 6a through 6f are inserted into the nozzle tip section 4.

As illustrated in FIG. 5, the nozzle tip section 4 has openings 9a through 9f (hereinafter, simply referred to as “opening 9” when the openings 9a through 9f are not distinguished from one another). Into the openings 9a through 9f, the corresponding path changing sections 6a through 6f are respectively inserted. The shapes of the openings 9a through 9f match or substantially match the corresponding path changing sections 6a through 6f, respectively.

A position of the opening 9 is not limited to between the opening 7 and a tip of the nozzle tip section 4, and may be between the opening 7 and the third body section 3 instead. The nozzle tip section 4 does not necessarily need to have the opening 7.

Change in Path of Film Material Caused by Path Changing Section

FIG. 6 is a view schematically illustrating a change in a path of a film material M, which change is caused by the at least one path changing section 6. The film material M is supplied in a top-to-bottom direction of a drawing sheet of FIG. 6. The at least one path changing section 6 is provided on the path of the film material M. When the film material M collides against the at least one path changing section 6, the path of the film material M is changed, so that the film material M flows along the path thus changed and reaches a surface of the base material 20. This causes a change in a film region on the base material 20 as compared with a film region that is formed in a case where the nozzle tip section 4 does not include the at least one path changing section 6. Thus, by changing the number, size, shape, position, and/or the like of the at least one path changing section 6 of the nozzle tip section 4 as appropriate, it is possible to control the film region on the surface of the base material 20.

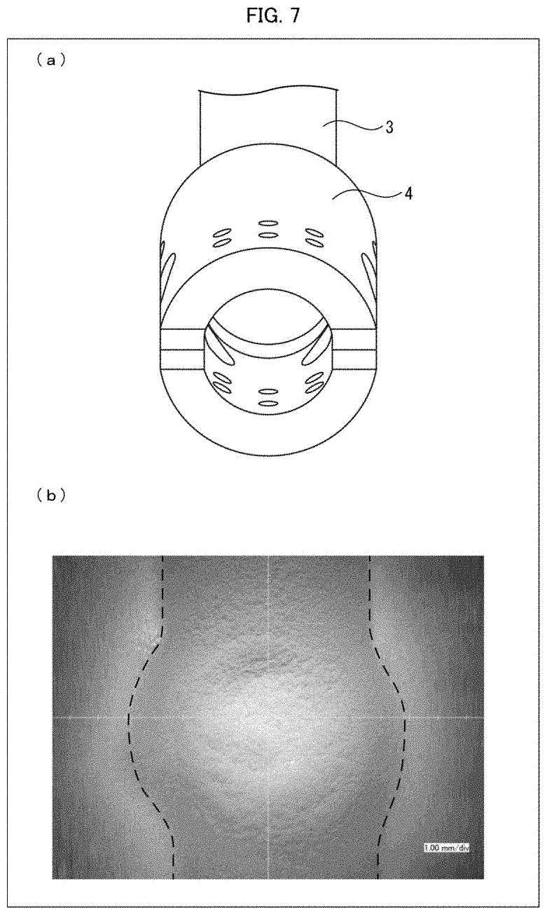

With reference to FIG. 7 etc., the following description will discuss a state of the surface of the base material 20 after film formation.

Observation of Surface of Base Material 20 after Film Formation

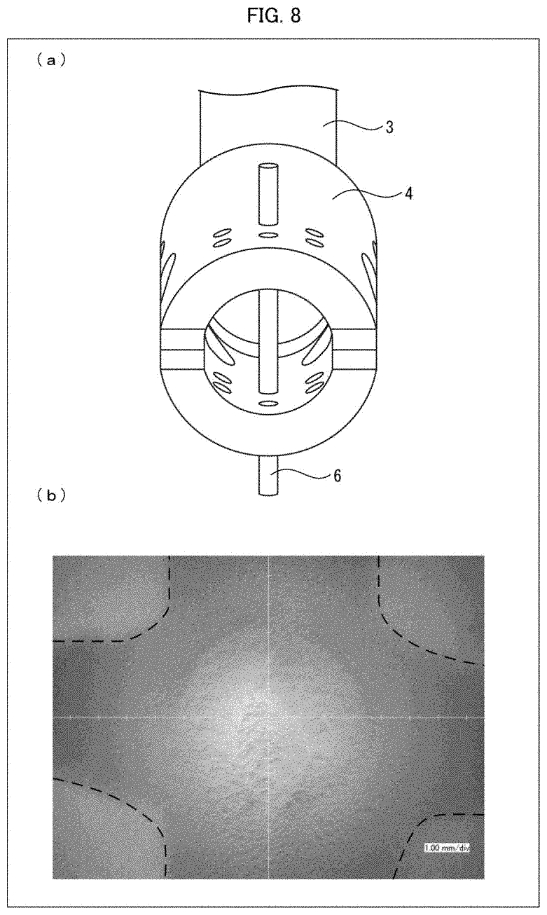

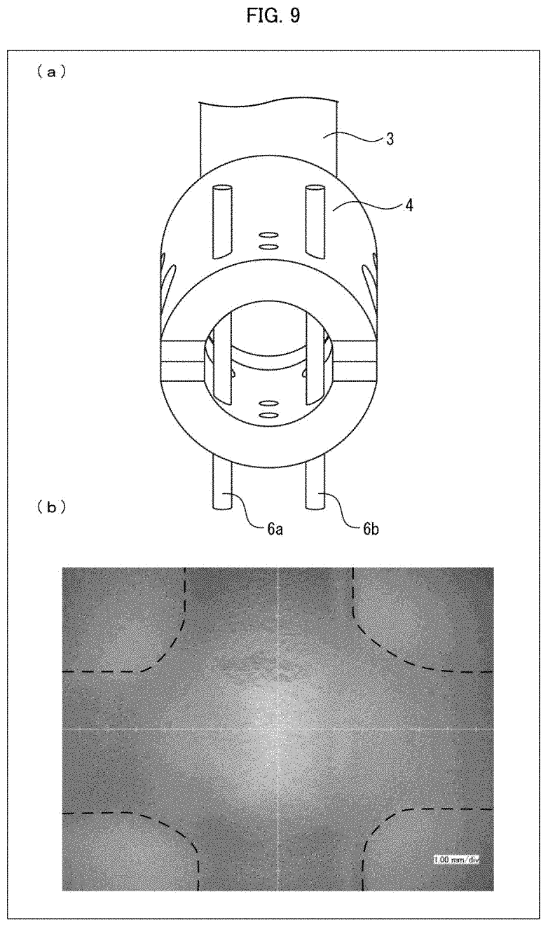

FIG. 7 is a photograph of the surface of the base material 20 on which a film of the film material has been formed without use of the at least one path changing section 6. (a) of FIG. 7 illustrates the nozzle tip section 4, and (b) of FIG. 7 is a photograph of the surface of the base material 20. FIG. 8 is a photograph of the surface of the base material 20 on which a film of the film material has been formed with use of one (1) path changing section 6. (a) of FIG. 8 illustrates the nozzle tip section 4, and (b) of FIG. 8 is a photograph of the surface of the base material 20. FIG. 9 is a photograph of the surface of the base material 20 on which a film of the film material has been formed with use of two path changing sections 6. (a) of FIG. 9 illustrates the nozzle tip section 4, and (b) of FIG. 9 is a photograph of the surface of the base material 20. In (b) of FIG. 7, (b) of FIG. 8, and (b) of FIG. 9, a top-bottom direction of respective drawing sheets of FIGS. 7, 8, and 9 represents a direction in which the nozzle moves, and a portion on inner sides of broken lines represents a film region.

In a case where a film of the film material is formed without use of the at least one path changing section 6, the film region formed extends along the direction in which the nozzle moves, and the film region does not expand in a direction (left-right direction of the sheet of FIG. 7) perpendicular to the direction in which the nozzle moves ((b) of FIG. 7). In contrast, in a case where a film of the film material is formed with use of the at least one path changing section 6, the film region extends also in a direction (left-right direction of the sheet of each of FIGS. 8 and 9) perpendicular to the direction in which the nozzle moves, due to a change in the path of the film material caused by the at least one path changing section 6 ((b) of FIG. 8 and (b) of FIG. 9). That is, in the cases illustrated in FIGS. 8 and 9, the nozzle tip section 4 can control a film-formed region so as to increase an area of the film formed.

As illustrated in (b) of FIG. 9, in a case where a film of the film material is formed with use of two path changing sections 6 (the path changing section 6a and the path changing section 6b), portions of the film region which portions are located immediately below the path changing section 6a and the path changing section 6b are light in color. This indicates that these portions have a small film thickness. In contrast, of the film region, a portion located between the portions located immediately below the path changing section 6a and the path changing section 6b is darker in color than the portions located immediately below the path changing section 6a and the path changing section 6b. This indicates that, of the film region, the portion located between the portions located immediately below the path changing section 6a and the path changing section 6b has a film thickness greater than that of each of the portions located immediately below the path changing section 6a and the path changing section 6b.

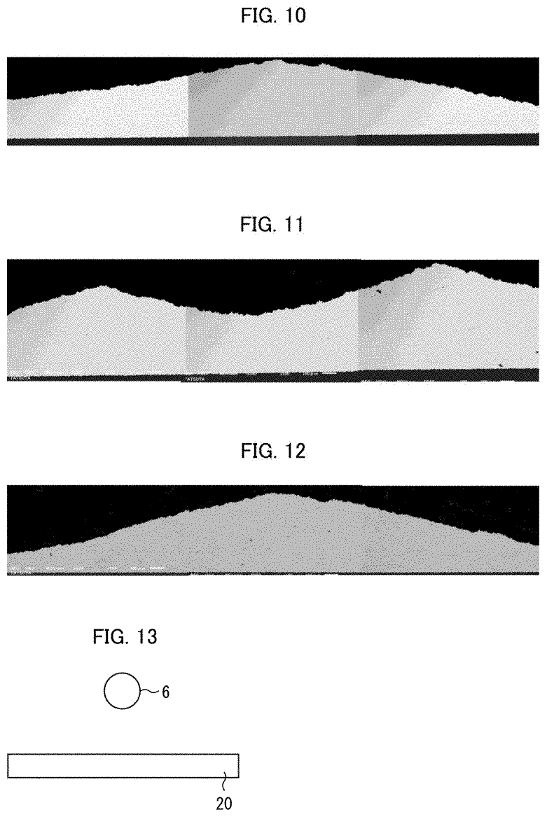

FIG. 10 is a cross-sectional view of a film region in a case where a film of the film material is formed on the base material 20 without use of the at least one path changing section 6. FIG. 11 is a cross-sectional view of a film region in a case where a film of the film material is formed on the base material 20 with use of one (1) path changing section 6. FIG. 12 is a cross-sectional view of a film region in a case where a film of the film material is formed on the base material 20 with use of two path changing sections 6. Conditions under which the film material is sprayed onto the base material 20 are the same among FIGS. 10 through 12.

In FIG. 10, the film region has a maximum film thickness of 0.700 mm, and has a film thickness of 0.590 mm at a position that is 0.4 mm away from a center of the film region. In FIG. 11, the film region has a maximum film thickness of 0.640 mm, and has a film thickness of 0.410 mm at a center of the film region. In FIG. 12, the film region has a maximum film thickness of 0.713 mm, and has a film thickness of 0.626 mm at a position that is 0.4 mm away from a center of the film region.

In the case illustrated in FIG. 11, the film region is formed so as to have a small film thickness in the vicinity of the center and have a maximum film thickness at a position slightly off the center. In FIG. 12, the maximum film thickness and the film thickness at the position that is 0.4 mm away from the center have numerical values respectively greater than those of the case illustrated in FIG. 10. There is a film thickness difference of approximately 0.01 mm between the maximum film thickness in FIG. 10 and the maximum film thickness in FIG. 12. This film thickness difference with the numerical value “0.01 mm” is understood by a person skilled in the art to be sufficiently significant.

In the spray nozzle 10 with the above arrangement, the at least one path changing section 6 causes a change in a path of the film material. The change in the path of the film material causes a change in a film region on the base material 20. Thus, the spray nozzle 10 can control the film region on the base material 20 with use of the at least one path changing section 6. In contrast, in the conventional technology, it is considered necessary to change a design of the nozzle main body in order to change the film region. It is also necessary in the conventional technology that restrictions imposed by a gas pressure and/or a gas flow rate of the carrier gas be taken into account when changing the design of the nozzle main body.

Thus, with the spray nozzle 10, it is possible to control a film-formed region to fall within a specific range (position, area, and the like) as compared with a case in which a conventional spray nozzle is used. Such an advantageous effect of the spray nozzle 10 can be brought about by provision of the at least one path changing section 6.

Position of at Least One Path Changing Section 6

As described above with reference to FIG. 8 etc., the at least one path changing section 6 may be attached to various positions.

In the example illustrated in FIG. 8, (i) the passage of the carrier gas in the nozzle tip section 4 is in a shape of a circle in a direction perpendicular to the direction in which the carrier gas flows and (ii) the at least one path changing section 6 has a rod-like shape. Further, in the direction perpendicular to the direction in which the carrier gas flows, the at least one path changing section 6 intersects the nozzle tip section 4 so as to overlap with a center of the circle.

In the example illustrated in FIG. 9, (i) the passage of the carrier gas in the nozzle tip section 4 is in a shape of a circle in a direction perpendicular to the direction in which the carrier gas flows and (ii) the path changing section 6a and the path changing section 6b each have a rod-like shape. Further, in the direction perpendicular to the direction in which the carrier gas flows, the path changing section 6a and the path changing section 6b intersect the nozzle tip section 4 so that a center of the circle is interposed between the path changing section 6a and the path changing section 6b. At this time, the path changing section 6a and the path changing section 6b may or may not be parallel to each other. In a case where the path changing section 6a and the path changing section 6b are parallel to each other, it is easy to process the nozzle tip section 4 (more specifically, the opening 9 of the nozzle tip section 4) into which the path changing section 6a and the path changing section 6b are inserted. Further, even in a case where the path changing section 6a and the path changing section 6b are not parallel to each other, it is possible to control a portion of the film region on the base material 20 which portion corresponds to an area between the path changing section 6a and the path changing section 6b.

Thus, the at least one path changing section 6 of the spray nozzle 10 can be provided at various positions. In all of such cases, the spray nozzle 10 can control a film region on the base material 20 easily as compared with the conventional technology.

Shape of at Least One Path Changing Section 6

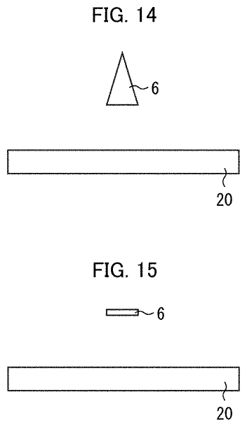

The following description will discuss a shape of the at least one path changing section 6, with reference to FIG. 13 etc. FIG. 13 is a view schematically illustrating a case in which a cross section of the at least one path changing section 6 taken along a direction in which the carrier gas flows is in a shape of a circle. FIG. 14 is a view schematically illustrating a case in which a cross section of the at least one path changing section 6 taken along a direction in which the carrier gas flows is in a shape of a triangle. FIG. 15 is a view schematically illustrating a case in which a cross section of the at least one path changing section 6 taken along a direction in which the carrier gas flows is in a shape of a rectangle.

As illustrated in FIGS. 13 through 15, the at least one path changing section 6 may be in various shapes. That is, it is only necessary that a cross section of the at least one path changing section 6 taken along the direction in which the carrier gas flows be in a shape that allows the path of the film material to be changed and accordingly allows the film material to be delivered onto the base material 20. In the example illustrated in FIG. 13, a cross section (a cross section of the at least one path changing section 6 taken along a direction perpendicular to a direction in which the at least one path changing section 6, which has a rod-like shape, extends) of the at least one path changing section 6 taken along the direction in which the carrier gas flows is in a shape of a circle. In the example illustrated in FIG. 14, a cross section (a cross section of the at least one path changing section 6 in a direction perpendicular to a direction in which the at least one path changing section 6, which has a rod-like shape, extends) of the at least one path changing section 6 taken along the direction in which the carrier gas flows is in a shape of a triangle. One of the three sides of the triangle is parallel to the surface of the base material 20. In a case where the shape of the above-described cross section is a circle or a triangle, the at least one path changing section 6 can cause a change in the path of the film material to thereby allow the film material to be delivered onto the base material 20. Further, the at least one path changing section 6 can form a film on the base material 20 more reliably, and thus can control the film region on the base material 20 even more easily. Other examples of the shape of the cross section of the at least one path changing section 6 taken along the direction in which the carrier gas flows include a rhombic shape, a square shape, a pentagonal shape or the like.

Note that, in the example illustrated in FIG. 15, the film material can accumulate on an upper surface of the at least one path changing section 6. However, even in a case where the at least one path changing section 6 illustrated in FIG. 6 is used, it is possible to cause a change in the path of the film material by the at least one path changing section 6. The change in the path of the film material causes a change in a film region on the base material 20. Further, since the at least one path changing section 6 is attachable to and detachable from the nozzle tip section 4, the at least one path changing section 6 can be replaced in a case where the film material accumulates on the upper surface of the at least one path changing section 6.

Thus, the at least one path changing section 6 of the spray nozzle 10 can be provided in various shapes. Accordingly, the spray nozzle 10 can control a film region on the base material 20 easily as compared with the conventional technology.

Aspects of the present invention can also be expressed as follows:

A spray nozzle in accordance with Aspect 1 of the present invention is a spray nozzle to be applied to a film forming device which sprays a film material, together with a carrier gas, onto a base material so as to form a film on the base material, including: a nozzle main body; a nozzle tip section connected to a tip of the nozzle main body; and at least one path changing section which is provided in a passage of the carrier gas in the nozzle tip section and changes a path of the film material.

With the above arrangement, in a spray nozzle in accordance with an embodiment of the present invention, the at least one path changing section causes a change in a path of the film material. The change in the path of the film material causes a change in a film region on the base material. Thus, the spray nozzle in accordance with an embodiment of the present invention can control a film region on the base material with use of the at least one path changing section.

In Aspect 2 of the present invention, the spray nozzle in accordance with Aspect 1 above may be arranged such that the nozzle tip section is attachable to and detachable from the nozzle main body.

With the above arrangement, the nozzle tip section can be attached to the nozzle main body in a case where the at least one path changing section is needed. Further, by preparing a plurality of kinds of nozzle tip sections in advance, it is possible to form a plurality of patterns of film regions on the base material easily.

Thus, a spray nozzle in accordance with an embodiment of the present invention can control a film region on the base material even more easily.

In Aspect 3 of the present invention, the spray nozzle in accordance with Aspect 1 or 2 above may be arranged such that the at least one path changing section is attachable to and detachable from the nozzle tip section.

With the above arrangement, the at least one path changing section can be easily replaced. Accordingly, by preparing a plurality of kinds of path changing sections in advance, it is possible to form a plurality of patterns of film regions on the base material easily.

Thus, a spray nozzle in accordance with an embodiment of the present invention can control a film region on the base material even more easily.

Further, the at least one path changing section can be easily replaced in a case where it becomes necessary to replace the at least one path changing section due to abrasion or the like. This brings about another advantage that a spray nozzle that is easy to use can be provided to a user.

In Aspect 4 of the present invention, the spray nozzle in accordance with any one of Aspects 1 through 3 above may be arranged such that the at least one path changing section is in a rod-like shape and is provided so as to intersect the passage of the carrier gas.

In Aspect 5 of the present invention, the spray nozzle in accordance with Aspect 4 above may be arranged such that the at least one path changing section is provided so as to (i) extend so as to pass through a center of a cross section of the passage of the carrier gas which cross section is taken along a plane perpendicular to a direction in which the carrier gas flows and (ii) be perpendicular to the direction in which the carrier gas flows.

With the above arrangement, it is possible to form a film region on the base material uniformly with respect to the at least one path changing section serving as a symmetrical axis.

In Aspect 6 of the present invention, the spray nozzle in accordance with Aspect 4 above may be arranged such that: the at least one path changing section is a plurality of path changing sections; and each of the plurality of path changing sections is provided so as to (i) extend so that a center of a cross section of the passage of the carrier gas which cross section is taken along a plane perpendicular to a direction in which the carrier gas flows is interposed between the plurality of path changing sections and (ii) be perpendicular to the direction in which the carrier gas flows.

The above arrangement makes it possible that, of a film region, a portion located between portions located immediately below the respective plurality of path changing sections has a film thickness greater than that of each of the portions located immediately below the respective plurality of path changing sections. That is, a spray nozzle in accordance with an embodiment of the present invention can control a certain portion of a film region to have a film thickness greater than that of another portion of the film region.

Thus, a spray nozzle in accordance with an embodiment of the present invention can control a film region easily and flexibly.

In Aspect 7 of the present invention, the spray nozzle in accordance with any one of Aspects 1 through 6 above may be arranged such that a cross section of the at least one path changing section which cross section is taken along a direction in which the carrier gas flows is in a shape that allows the path of the film material to be changed so that the film material is delivered onto the base material.

With the above arrangement, it is possible to form a film on the base material more reliably. This enables controlling a film region on the base material even more easily.

In Aspect 8 of the present invention, the spray nozzle in accordance with Aspect 7 above may be arranged such that a cross section of the at least one path changing section which cross section is taken along a direction in which the carrier gas flows is in a shape of a circle.

With the above arrangement, it is possible to form a film on the base material more efficiently.

In Aspect 9 of the present invention, the spray nozzle in accordance with Aspect 7 above may be arranged such that: a cross section of the at least one path changing section which cross section is taken along a direction in which the carrier gas flows is in a shape of a triangle; and one of three sides of the triangle is parallel to a surface of the base material.

With the above arrangement, it is possible to form a film on the base material more efficiently.

A film forming device in accordance with Aspect 10 of the present invention, which film forming device is characterized by including a spray nozzle, may be arranged such that, in any one of Aspects 1 through 9 above, the film forming device includes a spray nozzle recited in any one of claims 1 through 9.

With the above arrangement, a film forming device in accordance with an embodiment of the present invention can control a film region on the base material easily.

A film forming method in accordance with Aspect 11 of the present invention, which film forming method is characterized by using a spray nozzle and spraying the film material, together with the carrier gas, through the spray nozzle so as to form a film on the base material, may be a film forming method which, in any one of Aspects 1 through 9 above, uses a spray nozzle recited in any one of claims 1 through 9 and sprays the film material, together with the carrier gas, through the spray nozzle so as to form a film on the base material.

With the above arrangement, a film forming method in accordance with an embodiment of the present invention can control a film region on the base material easily.

In Aspect 12 of the present invention, the film forming method in accordance with Aspect 11 above may be a film forming method which is used in a thermal spray method.

The above arrangement enables easy control of a film region on the base material in the thermal spray method. Note here that the thermal spray method is a type of coating technique which forms a film by (i) melting or softening a film material by heating, (ii) microparticulating and accelerating the film material so that the film material collides with a surface of a base material so as to be crushed and flattened, and (iii) solidifying and accumulating particles of the film material. There are many types of thermal spraying, and the arrangement above allows the film forming method to be applied to the thermal spray methods in general.

The present invention is not limited to the embodiments, but can be altered by a skilled person in the art within the scope of the claims. The present invention also encompasses, in its technical scope, any embodiment derived by combining technical means disclosed in differing embodiments.

### REFERENCE SIGNS LIST

1: first body section
2: second body section
3: third body section
4: nozzle tip section
6: at least one path changing section
6a, 6b: path changing section
7, 8, 9, 9a: opening
10: spray nozzle
12: screw
20: base material
100: cold spray device
110: tank
120: heater
140: feeder
150: base material holder

1. A spray nozzle to be applied to a film forming device which sprays a film material, together with a carrier gas, onto a base material so as to form a film on the base material, comprising:
a nozzle main body;
a nozzle tip section connected to a tip of the nozzle main body; and
at least one path changing section which is provided in a passage of the carrier gas in the nozzle tip section and changes a path of the film material.

2. The spray nozzle as set forth in claim 1, wherein the nozzle tip section is attachable to and detachable from the nozzle main body.

3. The spray nozzle as set forth in claim 1, wherein the at least one path changing section is attachable to and detachable from the nozzle tip section.

4. The spray nozzle as set forth in claim 1, wherein the at least one path changing section is in a rod-like shape and is provided so as to intersect the passage of the carrier gas.

5. The spray nozzle as set forth in claim 4, wherein the at least one path changing section is provided so as to (i) extend so as to pass through a center of a cross section of the passage of the carrier gas which cross section is taken along a plane perpendicular to a direction in which the carrier gas flows and (ii) be perpendicular to the direction in which the carrier gas flows.

6. The spray nozzle as set forth in claim 4, wherein:
the at least one path changing section is a plurality of path changing sections; and
each of the plurality of path changing sections is provided so as to (i) extend so that a center of a cross section of the passage of the carrier gas which cross section is taken along a plane perpendicular to a direction in which the carrier gas flows is interposed between the plurality of path changing sections and (ii) be perpendicular to the direction in which the carrier gas flows.

7. The spray nozzle as set forth in claim 1, wherein a cross section of the at least one path changing section which cross section is taken along a direction in which the carrier gas flows is in a shape that allows the path of the film material to be changed so that the film material is delivered onto the base material.

8. The spray nozzle as set forth in claim 7, wherein a cross section of the at least one path changing section which cross section is taken along a direction in which the carrier gas flows is in a shape of a circle.

9. The spray nozzle as set forth in claim 7, wherein:
a cross section of the at least one path changing section which cross section is taken along a direction in which the carrier gas flows is in a shape of a triangle; and
one of three sides of the triangle is parallel to a surface of the base material.

10. A film forming device, comprising a spray nozzle recited in claim 1.

11. A film forming method which uses a spray nozzle recited in claim 1,
the film forming method comprising:
spraying the film material, together with the carrier gas, through the spray nozzle so as to form a film on the base material.

12. The film forming method as set forth in claim 11, wherein the film forming method is used in a thermal spray method.
